(19) United States
(12) Patent Application Publication
(10) Pub. No.: US 2006/0124322 A1
(43) Pub. Date: Jun. 15, 2006

(54) Method of and material for fire extinguishing

(76) Inventors: Tim Goldburt, Chappaqua, NY (US); Gennadiy Leplyanin, Ardsley, NY (US)

Correspondence Address: Ilya Zborovsky, 6 Schoolhouse Way, Dix Hills, NY, 11746, US

(21) Appl. No.: 11/011,341

(22) Filed: Dec. 14, 2004

(51) Int. Cl. A62C 2/00

(52) U.S. Cl. 169/46; 169/54

(57) ABSTRACT

A method of extinguishing forest fires has the steps of providing an aqueous fire extinguishing medium, introducing en aqueous medium into a fire, introducing into the aqueous medium an agent generating a steam or gas, and applying a steam/gas-water mixture in a region located on a border of a propagating flame area and a burnt out area, as well as on the frontmost part of the burnt out area, so that the mixture is displaced by wind onto a flame to extinguish the same.

### BACKGROUND OF THE INVENTION

The present invention relates to a method of and a material for fire extinguishing.

It is known that various methods and materials for extinguishing fires, in particular forest fires, include creating anti-fire spaces and obstacles, limiting of such objects which are inflammable, i.e. removing them from fallen trees, etc., the use of water for extinguishing fire to cool the reaction zone and the isolation of the zone from air and combustible vapors.

It is believed that the existing methods and materials can be further improved.

### SUMMARY OF THE INVENTION

Accordingly, it is an object of the present invention to provide a method of extinguishing fires, in particular forest fires, as well as a material for extinguishing forest fires, which is a further improvement to the existing methods and materials.

In keeping with these objects and with others which will become apparent hereinafter, one feature of the present invention resides, briefly stated, in a method of extinguishing forest fires, comprising the steps of providing an aqueous fire extinguishing medium; introducing into the fire extinguishing medium an agent which enhances generation of water; introducing into the aqueous medium an agent generating a water steam; and applying a steam-water mixture in a region located on a border of a propagating flame area and a burnt out area, as well as on a frontmost part of the burnt out area, so that the steam-water mixture is displaced by wind onto the flame to extinguish the same.

It is another feature of the present invention to provide a fire extinguishing material for extinguishing forest fires, comprising a steam-water mixture applicable in a region located on the border of a propagating flame area and burnt out area, as well as on the front-most part of the burnt out area, so that the steam-water mixture is displaced by wind onto the flame to extinguish the same.

When the method is performed and the material is formed in accordance with the present invention, it improves fire extinguishing properties with the use of the inventive solution.

The novel features which are considered as characteristic for the present invention are set forth in particular in the appended claims. The invention itself, however, both as to its construction and to its method of operation, together with additional objects and advantages thereof, will be best understood from the following description of specific embodiments when read in connection with the accompanying drawings.

### BRIEF DESCRIPTION OF THE DRAWINGS

FIG. 1 is a plan view of a fire zone, in which the inventive method and the inventive material are utilized.

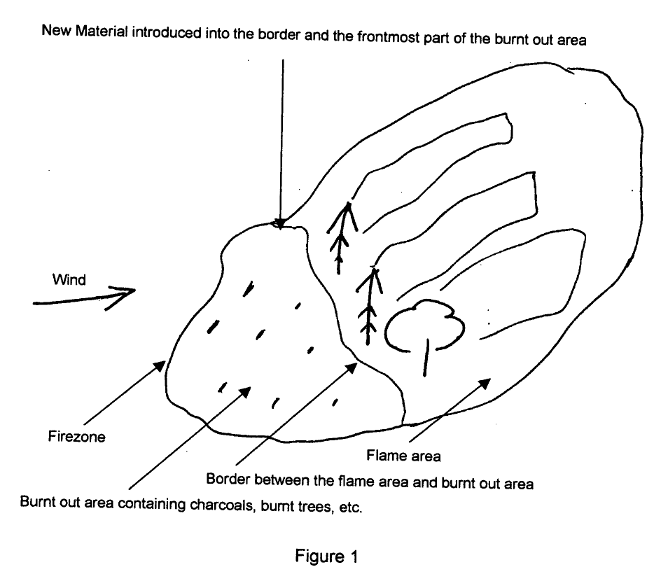

### DESCRIPTION OF THE PREFERRED EMBODIMENTS

In accordance with the present invention, for extinguishing fires, in particular forest fires, an aqueous medium, for example water is utilized, in which additionally an agent is introduced enhancing a generation of a water steam, so that a steam cloud or a gas-steam cloud is produced with a reduced content of oxygen. Thereby when the mixture is blown by wind onto a flame, burning is no longer maintained and a combustible material is isolated from atmospheric oxygen.

Preferably, the new material is introduced into a zone on a border between an area of flame and a burnt out area which contains charcoals, burnt trees, etc., as well as on the frontmost part of the burnt out area. When the steam or gas-steam cloud is generated, it is blown by wind onto the flame and extinguishes the flame.

In order to produce a steam or gas-steam cloud, an agent which generates steam and/or gas can be, for example, an aluminum powder in which aluminum grains are initially covered, for example with an oil coating for protection of aluminum from oxidation, and a solvent is introduced to dissolve the coating, for example kerosene. As a result, when the thusly produced material is applied, from one m³ of water with this additive 20,000 m³ steam/gas cloud can be produced, which does not maintain combustion.

As a result of the reaction between aluminum and water, a hydrogen is produced which, in combination with oxygen of air, produces multiple explosions for generating a gaseous cloud which produces a detonation gas.

In accordance with another embodiment of the present invention, the agent causing explosions can be azoizobytironitryl (dicyclogexyl and peroxydicarbonate). At elevated temperatures it decomposes causing explosions and generates nitrogen which is non combustible as well.

It is to be understood that the elevated temperature which causes this process is in the burnt out zone in which there is still a residual heat, for example in charcoals, and other slowly burning elements.

In accordance with a further feature of the present invention, a gel can be added to the material. The gel can be composed comprising a copolymer, with a plurality of links each including a derivative of an acrylic acid and a b-phenyl acrylic acid, with a same sequence of acrylic acid and b-phenyl acrylic acid in all links, wherein the derivatives of said acids. The copolymer is mixed with amides of said acids and ammonium salts of said acids. The copolymer is mixed with and swollen in water. In this case water instead of falling by individual drops on a surface, is uniformly distributed for example over the leaves of the plants completely covering them and isolating them from oxygen. Also, with the use of the gel, the quantity of the material to be used is significantly reduced for the same area of coverage.

In both cases the agent that creates individual explosions is added in form of drops which are decomposed with absorption of oxygen, being dispersed and evaporating the aqueous component.

It will be understood that each of the elements described above, or two or more together, may also find a useful application in other types of methods and substances differing from the types described above.

While the invention has been illustrated and described as embodied in a method of and material for fire extinguishing, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims:

1. A method of extinguishing forest fires, comprising the steps of providing an aqueous fire extinguishing medium; introducing an aqueous medium into a fire; introducing into the aqueous medium an agent generating a steam or gas; and applying a steam/gas-water mixture in a region located on a border of a propagating flame area and a burnt out area, as well as on the frontmost part of the burnt out area, so that the mixture is displaced by wind onto a flame to extinguish the same.

2. A method as defined in claim 1, wherein said introducing of the steam generating agent includes introducing such an agent which causes explosions in the aqueous medium.

3. A method as defined in claim 1, wherein said introducing agent includes introducing an agent which generates hydrogen.

4. A method as defined in claim 1, wherein said introducing includes introducing an agent which generates nitrogen.

5. A method as defined in claim 2, wherein said introducing of agent includes introducing of an agent which contains aluminum powder.

6. A method as defined in claim 2, wherein said introducing of introducing an agent which includes azoizobytironitryl (dicyclogexyl peroxy dicarbonate).

7. A method as defined in claim 1, wherein said aqueous medium is water.

8. A method as defined in claim 1; and further comprising introducing into said aqueous medium a gel for improving a uniform distribution of the fire extinguishing material over a desired zone.

9. A method as defined in claim 8, wherein said introducing of the gel include introducing of the gel comprising a copolymer with a plurality of links each including a derivative of acrylic acid and b-phenyl acrylic acid, with a same sequence of acrylic acid and the b-phenyl acrylic acid in all links, wherein derivatives of said acids are amides of said acids and ammonium salts of said acids, said copolymer being mixed with and swollen in water.

10. A fire extinguishing material for extinguishing forest fires, comprising an aqueous medium with an agent generating a steam gas to be applied in a region located on a border of a propagating flame area and a burnt out area as well as on the frontmost part of the burnt out area, so that the steam-water mixture is displaced by wind onto the flame to extinguish the same.

11. A fire extinguishing material defined in claim 10, wherein said steam/gas generating agent is an agent which causes explosions in the aqueous medium.

12. A fire extinguishing material defined in claim 10, wherein said steam/gas generating agent is an agent which generates hydrogen.

13. A fire extinguishing material defined in claim 11, wherein said steam/gas generating agent is an agent which generates nitrogen.

14. A fire extinguishing material defined in claim 12, wherein said nitrogen-generating agent is an agent which contains aluminum powder.

15. A fire extinguishing material defined in claim 14, wherein said agent which includes a substance selected from the group consisting of azoizobytironitryl (dicyclogexyl and peroxydicarbonate).

16. A fire extinguishing material defined in claim 10, wherein said aqueous medium is water.

17. A fire extinguishing material defined in claim 10; and further comprising introducing into said aqueous medium a gel for improving a uniform distribution of the fire extinguishing material over a desired zone.

18. A fire extinguishing material defined in claim 16, wherein said introducing of gel is a gel of a copolymer, with a plurality of links each including a derivative of acrylic acid and a b-phenyl acrylic acid, with a same sequence of acrylic acid and b-phenyl acrylic acid in all links, wherein derivatives of said acids are amides of said acids and ammonium salts of said acids, said copolymer being mixed with and swollen in water.
